(19) United States
(12) Patent Application Publication
(10) Pub. No.: US 2024/0086705 A1
(43) Pub. Date: Mar. 14, 2024

(54) COMPUTER-READABLE RECORDING MEDIUM STORING MACHINE LEARNING PROGRAM, MACHINE LEARNING METHOD, AND INFORMATION PROCESSING APPARATUS

(71) Applicant: Fujitsu Limited, Kawasaki-shi (JP)

(72) Inventors: Masayuki HIROMOTO, Kawasaki (JP); Akira NAKAGAWA, Sagamihara (JP)

(73) Assignee: Fujitsu Limited, Kawasaki-shi (JP)

(21) Appl. No.: 18/344,291

(22) Filed: Jun. 29, 2023

(30) Foreign Application Priority Data
Sep. 6, 2022 (JP) 2022-141496

(51) Int. Cl. G06N 3/08; G06N 3/0455

(52) U.S. Cl. CPC G06N 3/08; G06N 3/0455

(57) ABSTRACT

A non-transitory computer-readable recording medium stores a machine learning program causing a computer to execute a process including: calculating an average and a variance of a latent variable by inputting input data to an encoder; sampling a noise based on a normal distribution of the variance; calculating the latent variable by adding the noise to the average; calculating output data by inputting the calculated latent variable to a decoder; and training the encoder and the decoder in accordance with a loss function, the loss function including a value and an error between the input data and the output data, the value being obtained by multiplying encoding information by a correction coefficient based on the noise, the encoding information being information of a probability distribution of the latent variable and a prior distribution of the latent variable.

### CROSS-REFERENCE TO RELATED APPLICATION

This application is based upon and claims the benefit of priority of the prior Japanese Patent Application No. 2022-141496, filed on Sep. 6, 2022, the entire contents of which are incorporated herein by reference.

### FIELD

The embodiment discussed herein is related to a non-transitory computer-readable recording medium storing a machine learning program, and the like.

### BACKGROUND

In the field such as image processing or natural language processing, latent representations that capture features of data are generated by using a generative deep learning model. The generative deep learning model is trained based on a large amount of unlabeled data. The generative deep learning model is also referred to as a variational autoencoder (VAE).

I. Higgins, et al., “beta-VAE: Learning Basic Visual Concepts with a Constrained Variational Framework”, ICLR2017 is disclosed as related art.

### SUMMARY

According to an aspect of the embodiments, a non-transitory computer-readable recording medium stores a machine learning program causing a computer to execute a process including: calculating an average and a variance of a latent variable by inputting input data to an encoder; sampling a noise based on a normal distribution of the variance; calculating the latent variable by adding the noise to the average; calculating output data by inputting the calculated latent variable to a decoder; and training the encoder and the decoder in accordance with a loss function, the loss function including a value and an error between the input data and the output data, the value being obtained by multiplying encoding information by a correction coefficient based on the noise, the encoding information being information of a probability distribution of the latent variable and a prior distribution of the latent variable.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a variational autoencoder according to the present embodiment;

FIG. 2 is a functional block diagram illustrating a configuration of an information processing apparatus according to the present embodiment;

FIG. 3 is a flowchart illustrating a processing procedure of the information processing apparatus according to the present embodiment;

FIG. 4 is a diagram illustrating an example of a hardware configuration of a computer that implements a function in the same manner as the information processing apparatus according to the embodiment;

FIG. 5 is a diagram illustrating an example of a generative deep learning model; and

FIG. 6 is a diagram describing a β-VAE.

### DESCRIPTION OF EMBODIMENTS

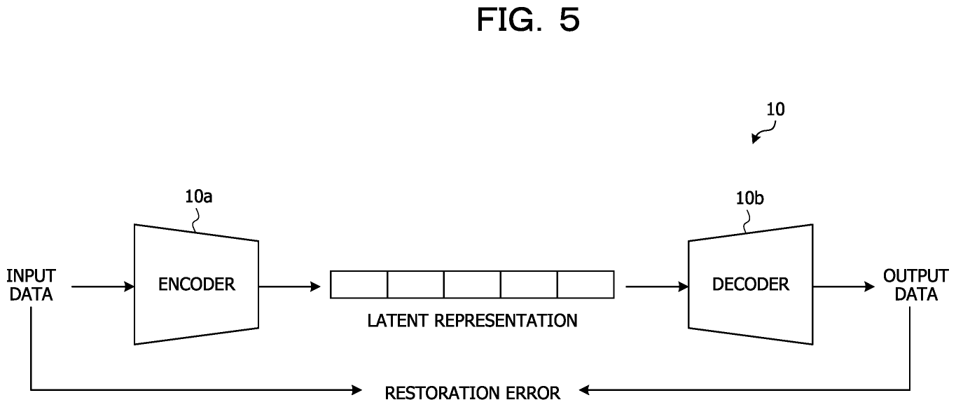

FIG. 5 is a diagram illustrating an example of a generative deep learning model. As illustrated in FIG. 5, a generative deep learning model 10 includes an encoder 10a and a decoder 10b. A latent representation is generated by inputting input data to the encoder 10a. By inputting the latent representation to the decoder 10b, output data that is a restored version of the input data is generated. The latent representation is low-dimensional data, and the data amount of latent representation is smaller than the data amount of input data (output data).

The encoder 10a and the decoder 10b are trained to reduce a restoration error between the input data and the output data. By inputting input data to the encoder 10a of the trained generative deep learning model 10, a latent representation that captures features of the input data is obtained.

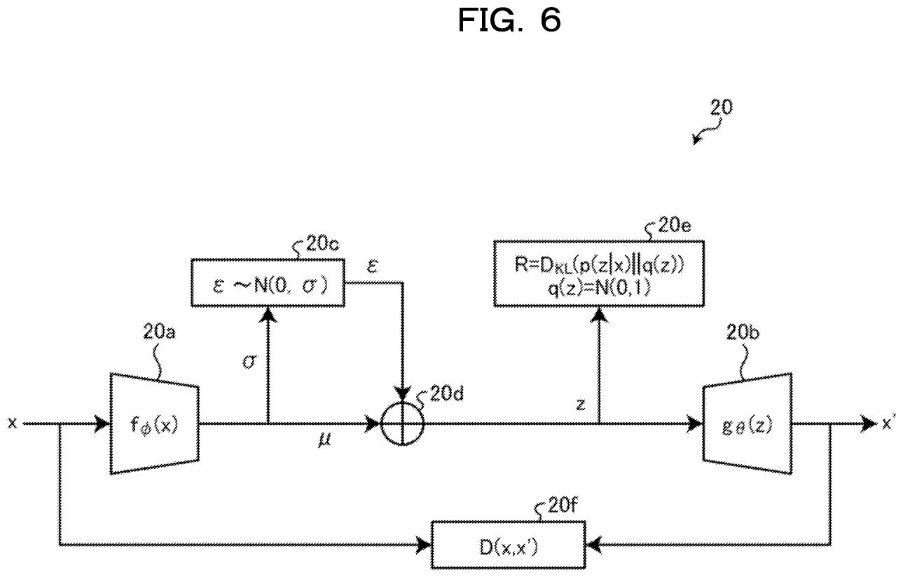

Subsequently, as the related art related to the generative deep learning model, β-VAE will be described. FIG. 6 is a diagram describing a β-VAE. As illustrated in FIG. 6, a β-VAE 20 includes an encoder 20a, a decoder 20b, a sampling unit 20c, an addition unit 20d, an encoding information amount generation unit 20e, and an error calculation unit 20f.

In a case where input data x is input, the encoder 20a calculates f_{φ}(X) based on a parameter φ. For example, the encoder 20a outputs μ and σ based on a calculation result of f_{φ}(X). μ is an average of calculation results (latent variable z). σ is a standard deviation of the calculation results. The encoder 20a may output a variance σ², instead of the standard deviation σ.

The sampling unit 20c samples ε (noise ε) according to a normal distribution of N(0, σ). The sampling unit 20c outputs the sampled ε to the addition unit 20d.

The addition unit 20d adds the average μ and the noise ε, and outputs the latent variable z that is an addition result.

The encoding information amount generation unit 20e calculates an encoding information amount R, based on Equation (1). q(z) included in Equation (1) is indicated by Equation (2). As indicated in Equation (2), q(z) is a normal distribution of N(0, 1). As a distribution of p(z|x) and a distribution of q(z) are more similar to each other, a value of the encoding information amount R is decreased.

R=D_{KL}(p(z|x)∥q(z)) (1)

q(z)=N(0,1) (2)

In a case where the latent variable z is input, the decoder 20b calculates g_{θ}(z) based on a parameter θ. The decoder 20b outputs output data x′ that is a calculation result of g_{θ}(z).

The error calculation unit 20f calculates a restoration error D between the input data x and the output data x′.

For example, the parameter φ of the encoder 20a and the parameter θ of the decoder 20b are trained by optimizations indicated in Equation (3). In Equation (3), β is a coefficient set in advance. For example, Equation (3) indicates that the parameters φ and θ are optimized to minimize an expected value E of a value obtained by adding the restoration error D and β×the encoding information amount R.

$$θ , ϕ = {arg min}_{θ , ϕ} ( {E}_{x \sim p ( x ) , ε \sim N ( 0 , σ )} [ D + β \cdot R ] ) \qquad ( 3 )$$

A loss function L1 of the β-VAE 20 for performing optimization is defined by Equation (4). The loss function L1 includes the restoration error D and a regularization term D_{KL}. The regularization term D_{KL} corresponds to the encoding information amount R indicated in Equation (1). The parameter φ of the encoder 20a and the parameter θ of the decoder 20b are trained such that a value of the loss function L1 is decreased.

L1=D(x, x′)+βD_{KL}(p(z|x)∥q(z)) (4)

By adding the noise ε sampled by the sampling unit 20c to the average μ of the latent variable z in the β-VAE 20, appropriate output data may be output even in a case where input data slightly different from input data used in training is input.

The loss function L1 indicated in Equation (4) includes the restoration error D and the regularization term D_{KL}. Although the restoration error D depends on the noise ε, the regularization term D_{KL} depends on the standard deviation σ (variance σ²). Therefore, there is a problem that a balance between the restoration error D and the regularization term D_{KL} fluctuates every time the noise ε is sampled, and convergence in training of the generative deep learning model deteriorates.

For example, a condition under which the loss function L1 takes a minimum value is indicated by Equation (5), and ideally depends on the standard deviation σ. Meanwhile, in reality, as indicated in Equation (6), the restoration error D is represented by |g(z)−g(z+ε)|². |g(z)−g(z+ε)|² is approximately equal to ε²g′(z)². Therefore, it may be said that the restoration error D is proportional to the noise ε², and since the restoration error D fluctuates in proportion to ε at each sampling, the convergence deteriorates.

$$\frac{dx}{dz} = \frac{\sqrt{β / 2}}{σ} \qquad ( 5 )$$

$$D ( x , {x}^{′} ) = \vert g ( z ) - g ( z + ε ) {\vert}^{2} ≃ {ε}^{2} {{g}^{′} ( z )}^{2} ∝ {ε}^{2} \qquad ( 6 )$$

In one aspect, an object of the present disclosure is to provide a machine learning program, a machine learning method, and an information processing apparatus capable of suppressing deterioration of convergence in training of a variational autoencoder.

Hereinafter, an embodiment of a machine learning program, a machine learning method, and an information processing apparatus disclosed in the present specification will be described in detail based on the drawings. This disclosure is not limited by the embodiment.

### EMBODIMENT

As described with reference to FIG. 6, in the β-VAE 20, the parameter φ of the encoder 20a and the parameter θ of the decoder 20b are trained by using the loss function L1 indicated in Equation (4). Although the restoration error D depends on the noise ε, the regularization term D_{KL} depends on the standard deviation σ (variance σ²). Therefore, in the β-VAE 20, a balance between the restoration error D and the regularization term D_{KL} fluctuates every time the noise ε is sampled, and convergence in training of the generative deep learning model deteriorates.

By contrast, the information processing apparatus according to the present embodiment trains the parameter φ of the encoder and the parameter θ of the decoder, based on a loss function L2 indicated by Equation (7).

$$L 2 = D ( x , {x}^{′} ) + β {\sum }_{j} \frac{{ε}_{j}^{2}}{{σ}_{j}^{2}} {D}_{KL} ( {σ}_{j} ) \qquad ( 7 )$$

“j” in Equation (7) indicates a dimension of a latent variable. As indicated in Equation (7), in the loss function L2, a correction coefficient based on the noise ε at a time of sampling is added to the regularization term D_{KL} of the loss function L2. The correction coefficient is calculated by “εⱼ²/σⱼ²” for each dimension j, is multiplied by D_{KL} for each dimension, and is added. D_{KL}(σⱼ) in Equation (7) means that the regularization term D_{KL} depends on the standard deviation σ. D_{KL}(σⱼ) corresponds to the encoding information amount R indicated in Equation (1). β is a coefficient that is set in advance.

As indicated in Equation (7), by adding the correction coefficient to the regularization term D_{KL} of the loss function L2, it is possible to make the regularization term D_{KL} of the loss function dependent on the noise ε. For example, since the restoration error D included in the loss function L2 and the regularization term D_{KL} are dependent on the noise ε, it is possible to suppress deterioration in convergence in training of the variational autoencoder.

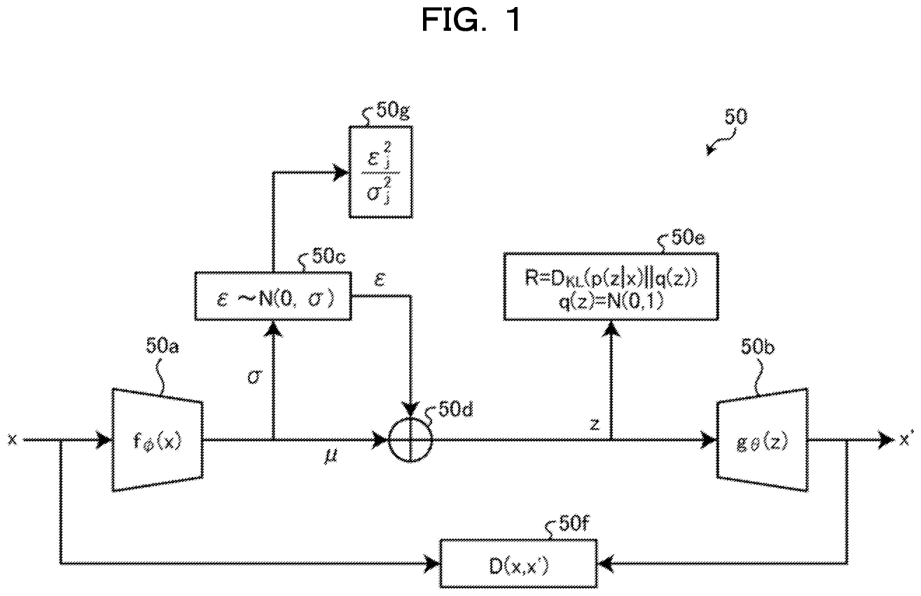

Next, an example of a variational autoencoder (generative deep learning model) trained by the information processing apparatus according to the present embodiment will be described. FIG. 1 is a diagram illustrating a variational autoencoder according to the present embodiment. As illustrated in FIG. 1, a variational autoencoder 50 includes an encoder 50a, a decoder 50b, a sampling unit 50c, an addition unit 50d, an encoding information amount generation unit 50e, an error calculation unit 50f, and a correction coefficient calculation unit 50g.

The information processing apparatus inputs the input data x to the encoder 50a. In a case where the input data x is input, the encoder 50a calculates f_{φ}(X) based on the parameter φ. For example, the encoder 50a outputs the average μ and the standard deviation σ of the latent variable z, based on a calculation result of f_{φ}(X). The encoder 20a may output the variance σ², instead of the standard deviation σ.

The sampling unit 50c samples ε according to a normal distribution of N(0, σ). The sampling unit 50c outputs the sampled ε (noise ε) to the addition unit 50d. The sampling unit 50c outputs the standard deviation σ (variance σ²) to the correction coefficient calculation unit 50g.

The addition unit 50d adds the average μ and the noise ε, and outputs the latent variable z as an addition result to the decoder 50b and the encoding information amount generation unit 50e.

The encoding information amount generation unit 50e calculates the encoding information amount R based on Equation (1). q(z) included in Equation (1) is indicated by Equation (2). As indicated in Equation (2), q(z) is a normal distribution of N(0, 1). As a distribution of p(z|x) and a distribution of q(z) are more similar to each other, a value of the encoding information amount R is decreased.

D_{KL} in Equation (1) is an amount of Kullback-Leibler information, and is defined by Equation (8).

$${D}_{KL} ( P ‖ Q ) = {\sum }_{i} P ( i ) log \frac{P ( i )}{Q ( i )} \qquad ( 8 )$$

In a case where the latent variable z is input, the decoder 50b calculates g_{θ}(z), based on the parameter θ. The decoder 50b outputs the output data x′ that is a calculation result of g_{θ}(z).

The error calculation unit 50f calculates the restoration error D between the input data x and the output data x′. The restoration error D is a distance between the input data x and the output data x′. The error calculation unit 50f may calculate the restoration error D, based on cross-entropy, a sum of squared differences, or the like.

The correction coefficient calculation unit 50g calculates the correction coefficient described above, based on the noise ε and the standard deviation σ (variance σ²). The correction coefficient calculation unit 50g calculates the correction coefficient “εⱼ²/σⱼ²” for each dimension j.

Based on Equation (7), the information processing apparatus calculates a value of the loss function L2, and updates the parameter φ of the encoder 50a and the parameter θ of the decoder 50b such that the value of the loss function L2 is decreased. For example, the information processing apparatus performs optimization indicated in Equation (9).

$$θ , ϕ = {arg min}_{θ , ϕ} ( {E}_{x \sim p ( x ) , ε \sim N ( 0 , σ )} [ L 2 ] ) \qquad ( 9 )$$

The information processing apparatus acquires the restoration error D from the error calculation unit 50f. The information processing apparatus acquires a value of the regularization term D_{KL} from the encoding information amount generation unit 50e. The information processing apparatus acquires the correction coefficient “εⱼ²/σⱼ²” for each dimension j from the correction coefficient calculation unit 50g.

Each time the input data x is input to the encoder 50a, the information processing apparatus repeatedly executes the process described above. For example, the information processing apparatus repeatedly executes the process described above until the parameter φ of the encoder 50a and the parameter θ of the decoder 50b converge.

As described above, the information processing apparatus according to the present embodiment gives a correction coefficient to a non-noise dependent normalization term, and updates the parameter φ of the encoder 50a and the parameter θ of the decoder 50b by using the loss function L2 set to the same noise dependent term as a restoration error. Accordingly, it is possible to suppress deterioration in convergence in training of the variational autoencoder 50.

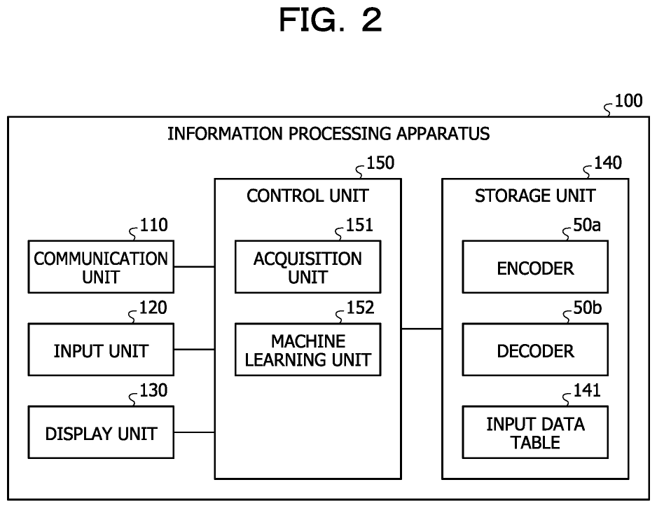

Next, a configuration example of the information processing apparatus according to the present embodiment is described. FIG. 2 is a functional block diagram illustrating a configuration of the information processing apparatus according to the present embodiment. As illustrated in FIG. 2, an information processing apparatus 100 includes a communication unit 110, an input unit 120, a display unit 130, a storage unit 140, and a control unit 150.

The communication unit 110 executes data communication with an external apparatus or the like via a network. The control unit 150 to be described later exchanges data with the external apparatus via the communication unit 110.

The input unit 120 is an input device that inputs various types of information to the control unit 150 of the information processing apparatus 100. The input unit 120 corresponds to a keyboard, a mouse, a touch panel, or the like.

The display unit 130 is a display device that displays information output from the control unit 150.

The storage unit 140 includes an encoder 50a, a decoder 50b, and an input data table 141. The storage unit 140 corresponds to a semiconductor memory element such as a random-access memory (RAM) or a flash memory, or a storage device such as a hard disk drive (HDD).

The encoder 50a is read and executed by the control unit 150. In a case where the input data x is input, the encoder 50a calculates f_{φ}(X) based on the parameter φ. Before training, an initial value of the parameter φ is set in the encoder 50a. The encoder 50a corresponds to the encoder 50a described with reference to FIG. 1.

The decoder 50b is read and executed by the control unit 150. In a case where the latent variable z is input, the decoder 50b calculates g_{θ}(z), based on the parameter θ. Before training, an initial value of the parameter θ is set in the decoder 50b. The decoder 50b corresponds to the decoder 50b described with reference to FIG. 1.

The input data table 141 holds a plurality of pieces of input data used for training the variational autoencoder 50. The input data registered in the input data table 141 is unlabeled input data.

The control unit 150 includes an acquisition unit 151 and a machine learning unit 152. The control unit 150 is implemented by a central processing unit (CPU) or a graphics processing unit (GPU), a hard wired logic such as an application-specific integrated circuit (ASIC) or a field-programmable gate array (FPGA), and the like.

The acquisition unit 151 acquires data of the input data table 141 from an external apparatus via a network, and stores the acquired data of the input data table 141 in the storage unit 140.

The machine learning unit 152 executes training of the variational autoencoder 50. For example, the machine learning unit 152 includes the addition unit 50d, the encoding information amount generation unit 50e, the error calculation unit 50f, and the correction coefficient calculation unit 50g illustrated in FIG. 1, and executes the process described with reference to FIG. 1.

The machine learning unit 152 reads the encoder 50a and the decoder 50b from the storage unit 140, inputs input data in the input data table 141 to the encoder 50a, and updates the parameter φ of the encoder 50a and the parameter θ of the decoder 50b such that a value of the loss function L2 indicated by Equation (7) is decreased. Until the parameter φ of the encoder 50a and the parameter θ of the decoder 50b converge, the machine learning unit 152 repeatedly executes the process described above.

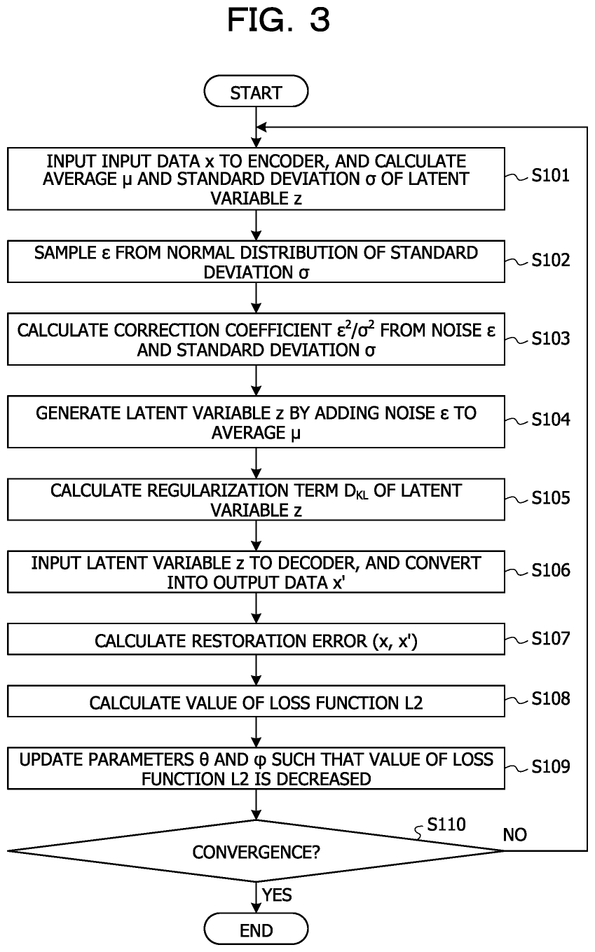

Next, an example of a processing procedure of the information processing apparatus 100 according to the present embodiment will be described. FIG. 3 is a flowchart illustrating a processing procedure of the information processing apparatus according to the present embodiment. As illustrated in FIG. 3, the machine learning unit 152 of the information processing apparatus 100 inputs the input data x to the encoder 50a, and calculates the average μ and the standard deviation σ (variance σ²) of the latent variable z (step S101).

From a normal distribution of the standard deviation σ (variance σ²), the machine learning unit 152 samples ε (step S102). Based on the noise ε and the standard deviation σ (variance σ²), the machine learning unit 152 calculates the correction coefficient ε²/σ² (step S103).

By adding the noise ε to the average μ, the machine learning unit 152 generates the latent variable z (step S104). The machine learning unit 152 calculates the regularization term D_{KL} of the latent variable z (step S105).

The machine learning unit 152 inputs the latent variable z to the decoder 50b, and converts the latent variable z into the output data x′ (step S106). The machine learning unit 152 calculates the restoration error D (x, x′) (step S107).

The machine learning unit 152 calculates a value of the loss function L2 (step S108). The machine learning unit 152 updates the parameters θ and φ such that a value of the loss function L2 is decreased (step S109).

The machine learning unit 152 determines whether or not the parameters θ and φ converge (step S110). In a case where the parameters θ and φ do not converge (No in step S110), the machine learning unit 152 shifts the process to step S101. In a case where the parameters θ and φ converge (Yes in step S110), the machine learning unit 152 ends the process.

The processing procedure illustrated in FIG. 3 is an example. For example, the machine learning unit 152 may execute the process illustrated in step S103 at any timing between steps S102 to S108. The machine learning unit 152 may execute the process illustrated in step S105 at any timing between steps S104 to S108.

Next, effects of the information processing apparatus 100 according to the present embodiment are described. The information processing apparatus 100 gives a correction coefficient to a non-noise dependent normalization term, and updates the parameter φ of the encoder 50a and the parameter θ of the decoder 50b by using the loss function L2 set to the same noise dependent term as a restoration error. Accordingly, it is possible to suppress deterioration in convergence in training of the variational autoencoder 50.

Based on the noise ε and the average μ of the latent variables, the information processing apparatus 100 calculates a correction coefficient, and gives the correction coefficient to the regularization term D_{KL} of the loss function L2. Accordingly, since the restoration error D and the regularization term D_{KL} included in the loss function L2 are dependent on the noise ε, convergence in training of the variational autoencoder 50 is improved. Orthogonality of the latent variables is improved, and accuracy of the variational autoencoder 50 is improved.

The information processing apparatus 100 calculates a correction coefficient for each dimension j of a latent variable, and trains the variational autoencoder 50 to minimize values of a sum value of results obtained by multiplying the regularization term D_{KL} for each dimension j by a correction coefficient for each dimension j and the restoration error D. Accordingly, it is possible to suppress deterioration in convergence in training of the variational autoencoder 50.

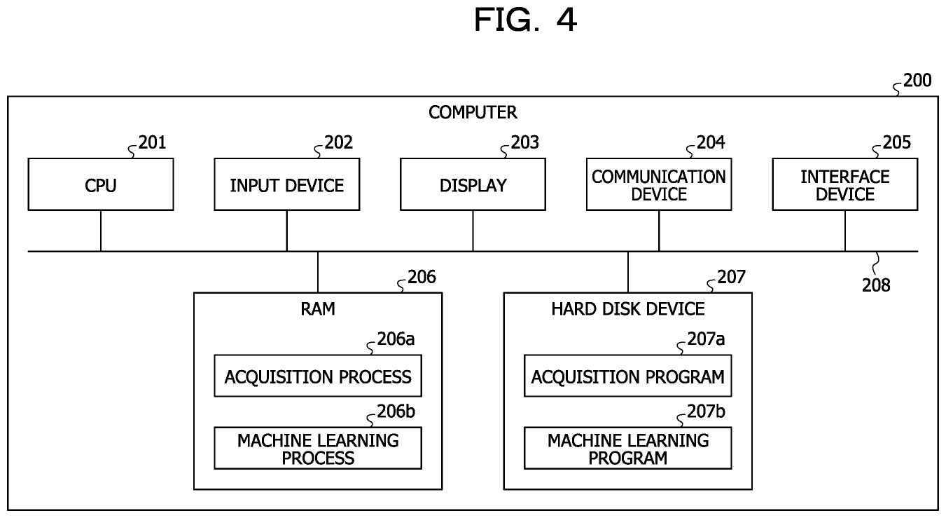

Next, an example of a hardware configuration of a computer that implements a function in the same manner as the function of the information processing apparatus 100 described above is described. FIG. 4 is a diagram illustrating an example of a hardware configuration of a computer that implements the function in the same manner as the function of the information processing apparatus according to the embodiment.

As illustrated in FIG. 4, a computer 200 includes a CPU 201 that executes various types of arithmetic processes, an input device 202 that receives an input of data from a user, and a display 203. The computer 200 also includes a communication device 204 that exchanges data with an external apparatus or the like via a wired or wireless network, and an interface device 205. The computer 200 also includes a RAM 206 that temporarily stores various types of information, and a hard disk device 207. Each of the devices 201 to 207 is coupled to a bus 208.

The hard disk device 207 includes an acquisition program 207a and a machine learning program 207b. The CPU 201 reads each of the programs 207a and 207b, and loads each of the programs 207a and 207b onto the RAM 206.

The acquisition program 207a functions as an acquisition process 206a. The machine learning program 207b functions as a machine learning process 206b.

A process of the acquisition process 206a corresponds to a process of the acquisition unit 151. A process of the machine learning process 206b corresponds to a process of the machine learning unit 152.

Each of the programs 207a and 207b may not necessarily have to be stored in the hard disk device 207 from the beginning. For example, each program may be stored in a “portable physical medium” such as a flexible disk (FD), a compact disk read-only memory (CD-ROM), a Digital Versatile Disc (DVD), a magneto-optical disk, an integrated circuit (IC) card, or the like inserted in the computer 200. The computer 200 may read and execute each of the programs 207a and 207b.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program causing a computer to execute a process comprising:
calculating an average and a variance of a latent variable by inputting input data to an encoder;
sampling a noise based on a normal distribution of the variance;
calculating the latent variable by adding the noise to the average;
calculating output data by inputting the calculated latent variable to a decoder; and
training the encoder and the decoder in accordance with a loss function, the loss function including a value and an error between the input data and the output data, the value being obtained by multiplying encoding information by a correction coefficient based on the noise, the encoding information being information of a probability distribution of the latent variable and a prior distribution of the latent variable.

2. The non-transitory computer-readable recording medium according to claim 1,
wherein the machine learning program causes the computer to further execute a process of calculating the correction coefficient based on the noise and the average.

3. The non-transitory computer-readable recording medium according to claim 2,
wherein in the calculating of the correction coefficient, the correction coefficient is calculated for each dimension of the latent variable, and
in the training, the encoder and the decoder are trained to minimize values of a sum value of results obtained by multiplying the encoding information for each dimension by the correction coefficient for each dimension and the error.

4. A machine learning method comprising:
calculating an average and a variance of a latent variable by inputting input data to an encoder;
sampling a noise based on a normal distribution of the variance;
calculating the latent variable by adding the noise to the average;
calculating output data by inputting the calculated latent variable to a decoder; and
training the encoder and the decoder in accordance with a loss function, the loss function including a value and an error between the input data and the output data, the value being obtained by multiplying encoding information by a correction coefficient based on the noise, the encoding information being information of a probability distribution of the latent variable and a prior distribution of the latent variable.

5. The machine learning method according to claim 4, further comprising:
executing a process of calculating the correction coefficient based on the noise and the average.

6. The machine learning method according to claim 5,
wherein in the calculating of the correction coefficient, the correction coefficient is calculated for each dimension of the latent variable, and
in the training, the encoder and the decoder are trained to minimize values of a sum value of results obtained by multiplying the encoding information for each dimension by the correction coefficient for each dimension and the error.

7. An information processing apparatus comprising:
a memory; and
a processor coupled to the memory and configured to:
calculate an average and a variance of a latent variable by inputting input data to an encoder;
sample a noise based on a normal distribution of the variance;
calculate the latent variable by adding the noise to the average;
calculate output data by inputting the calculated latent variable to a decoder; and
train the encoder and the decoder in accordance with a loss function, the loss function including a value and an error between the input data and the output data, the value being obtained by multiplying encoding information by a correction coefficient based on the noise, the encoding information being information of a probability distribution of the latent variable and a prior distribution of the latent variable.

8. The information processing apparatus according to claim 7,
wherein the processor executes a process of calculating the correction coefficient based on the noise and the average.

9. The information processing apparatus according to claim 8,
wherein in the calculating of the correction coefficient, the correction coefficient is calculated for each dimension of the latent variable, and
in the training, the encoder and the decoder are trained to minimize values of a sum value of results obtained by multiplying the encoding information for each dimension by the correction coefficient for each dimension and the error.
